(19) United States
(12) Patent Application Publication
(10) Pub. No.: US 2014/0219473 A1
(43) Pub. Date: Aug. 7, 2014

(54) SIGNAL FILTERING APPARATUS AND SIGNAL FILTERING METHOD

(71) Applicant: MStar Semiconductor, Inc., Hsinchu Hsien (TW)

(72) Inventor: Chu-Feng Lien, Hsinchu Hsien (TW)

(73) Assignee: MStar Semiconductor, Inc., Hsinchu Hsien (TW)

(21) Appl. No.: 14/160,980

(22) Filed: Jan. 22, 2014

(30) Foreign Application Priority Data
Feb. 4, 2013 (TW) 102104230

(51) Int. Cl. H04R 3/04

(52) U.S. Cl. CPC H04R 3/04
USPC 381/98

(57) ABSTRACT

The present invention provides a signal filtering apparatus, which comprises a control circuit and a filter for receiving a transmitted input signal and generating an output signal. The filter comprises multiple filter taps for processing the transmitted input signal corresponding to different timings with different filter coefficients, respectively, to generate the output signal. The control circuit is configured to shrink at least part of the low-frequency-response filter taps having filter coefficients less than a predetermined value.

### CROSS REFERENCE TO RELATED APPLICATIONS

This application claims priority under 35 U.S.C. 119 to Taiwan patent application, TW102104230, filed on Feb. 4, 2013, the disclosure of which is incorporated herein by reference.

### BACKGROUND OF THE INVENTION

1. Field of the Invention

The present invention relates to a signal filtering apparatus and signal filtering method, and more particularly, to a signal filtering apparatus and signal filtering method capable of shrinking filtering taps appropriately.

2. Description of the Prior Art

When using an audio system, such as a microphone, echo phenomena may occur due to equipment or environment factors, resulting in difficulties in recognizing correct audio signals. Thus, echo calibration mechanisms are required. Among the conventional echo calibration mechanisms, there is one echo calibration mechanism utilizing adaptive filter.

FIG. 1 shows a schematic block diagram of an echo calibration mechanism utilizing adaptive filter according to the prior art. As shown in FIG. 1, an adaptive filter 101 receives a transmitted input signal TIN. The TIN signal (i.e., an audio signal) is formed after an original input signal OIN traversing through a transmission medium 103. The transmission medium 103 may be visible devices such as transmission wires and interfaces or invisible medium such as signal transmission channels in wireless communication. An output signal OS is generated after the TIN signal is processed by the adaptive filter 101. The OS signal is compared with a delayed original input signal DOIN by a subtractor 107 to generate an error signal ERS representing the difference of these two signals. Since the DOIN signal is generated by delaying the OIN signal by a delay unit 105, the ERS signal could also be viewed as the difference or error between the OS signal and the OIN signal. By utilizing the mechanism, the filtering coefficients of the adaptive filter 101 could be adjusted iteratively such that the ERS signal is convergent and smaller than or equals to a predetermined level (e.g., zero.) In case the ERS signal is smaller than or equals to the predetermined level, it represents that the OS signal and the OIN signal are pretty closed or consistent, thus the error caused by the transmission medium 103 has been corrected.

Usually, the adaptive filter 101 includes multiple filtering taps. Each of the taps has different filtering coefficient for filtering the TIN signals corresponding to different timing. Some of these filtering taps have smaller frequency responses. Thus the corresponding filtering coefficients are quite small and approximately approach to zero. However, all these filter taps would be recalculated each time the coefficients are adjusted. As a result, not only electric energy is wasted, the convergence process (i.e., the filtering coefficients are stabilized such that the ERS signal is smaller or equals to the predetermined level) of the filtering coefficients is also prolonged.

### SUMMARY OF THE INVENTION

One of objectives of the present invention is to provide a signal filtering apparatus capable of shrinking filter taps appropriately.

Another one of objectives of the present invention is to provide a signal filtering method capable of shrinking filter taps appropriately.

One embodiment of the present invention provides a signal filtering apparatus, which comprises a control circuit and a filter for receiving a transmitted input signal and generating an output signal. The filter comprises multiple filter taps for processing the transmitted input signal corresponding to different timings with different filter coefficients, respectively, to generate the output signal. The control circuit is configured to shrink at least part of the low-frequency-response filter taps having filter coefficients less than a predetermined value.

Another embodiment of the present invention provides a signal filtering method, comprising: receiving a transmitted input signal and processing the transmitted input signal corresponding to different timings by multiple filter taps of a filter with different filter coefficients, respectively, to generate an output signal; and shrinking at least a part of the low-frequency-response filter taps having filter coefficients less than a predetermined value.

According to the embodiments, outputs from the low-frequency-response filter taps are excluded. Consequently, electric energy could be saved and the convergence speed of filter coefficient could be accelerated.

### BRIEF DESCRIPTION OF THE DRAWINGS

FIG. 1 is a schematic block diagram of an echo calibration mechanism utilizing adaptive filter.

FIG. 2 is a schematic block diagram of a signal filtering apparatus according to an embodiment of the present invention.

FIG. 3 is a schematic block diagram illustrates an example of details of the adaptive filter 201 shown in FIG. 2.

FIG. 4 and FIG. 5 are operation diagrams of filter tap shrinking steps performed by the signal filtering apparatus shown in FIG. 2.

FIG. 6 is a flowchart diagram of the operation performed by the adaptive filter shown in FIG. 2.

### DETAILED DESCRIPTION OF THE PREFERRED EMBODIMENTS

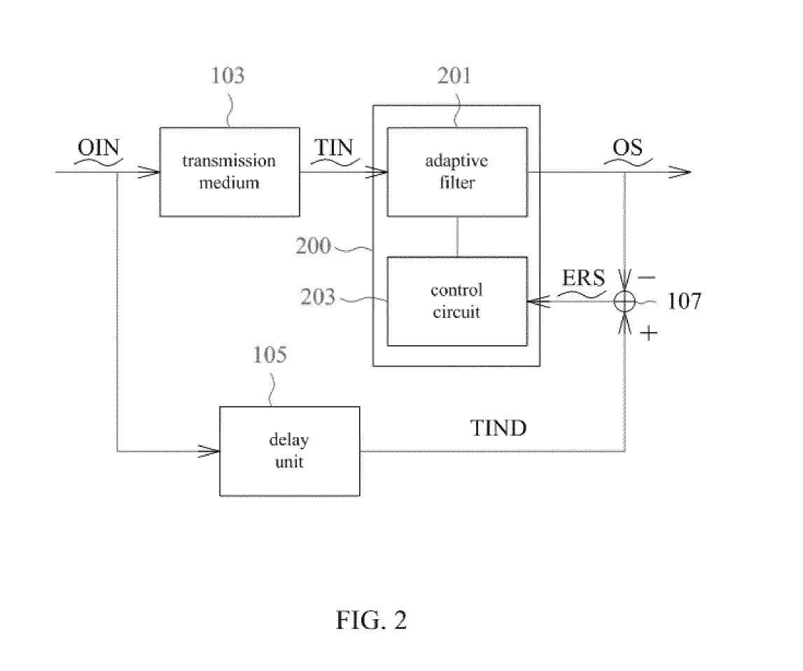

FIG. 2 depicts a schematic block diagram of a signal filtering apparatus 200 according to an embodiment of the present invention. As shown in FIG. 2, the signal filtering apparatus 200 includes an adaptive filter 201 which is capable of performing operations of the adaptive filter 101. In addition to the adaptive filter 201, the signal filtering apparatus further includes a control circuit 203 which is configured to shrink the filter taps. By realizing this mechanism, not all outputs of the filter taps need to be calculated. Following paragraphs would describe details of shrinking the filter taps. However, please note that in the embodiment shown in FIG. 2, although the control circuit 203 further receives the ERS signal to control the filtering coefficients of filter taps, the two actions: controlling the filtering coefficients according to the ERS signal as well as the shrinking of filter taps are not necessarily done by a single circuit. These two actions could be done by different circuits. The control circuit 203 may be implemented by firmware or software such as executing a program by a processor unit. Alternatively, the control circuit 203 may be a separate hardware.

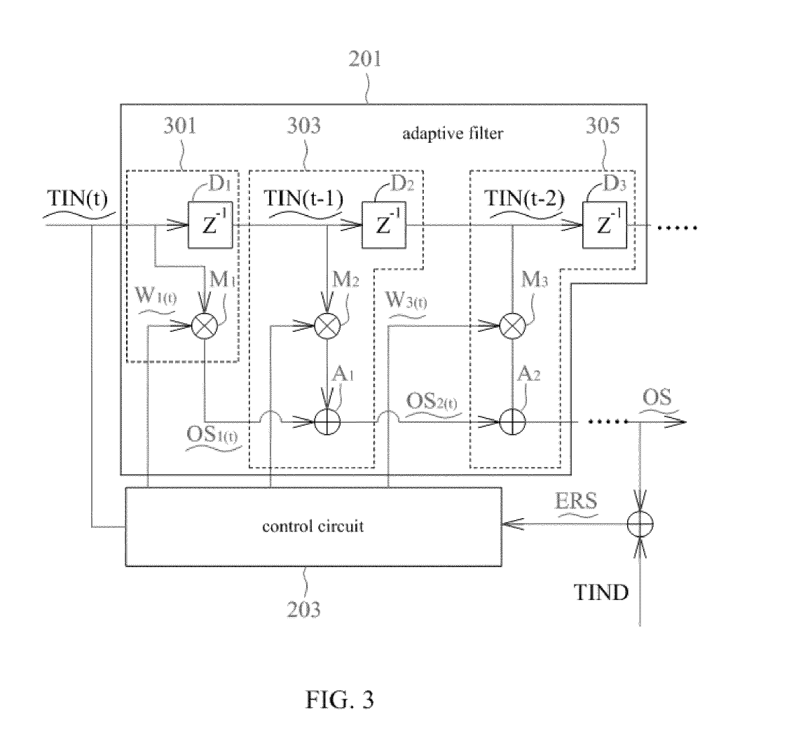

FIG. 3 illustrates a detailed block diagram of the adaptive filter 201 in FIG. 2 according to an embodiment of the present invention. Please note that only three filter taps 301, 303, and 305 are shown for brevity. As shown in FIG. 3, the initial filter tap 301 includes a delay unit D₁, a multiplier M₁, and no adder (it does not construct a limitation to the present invention.) The structures of the rest two filter taps are identical. The filter tap 303 includes a delay unit D₂, a multiplier M₂, and an adder A₁. The filter tap 305 also includes a delay unit D₃, a multiplier M₃, and an adder A₂. The delay unit D₁ of the filter tap 301 is configured to delay a cycle of the TIN signal. In this embodiment, the TIN signal is denoted as TIN(t) and the delayed TIN signal is denoted as TIN(t-1). The signal with one more cycle delayed than the TIN(t-1) signal is denoted as TIN(t-2). The multiplier M₁ is configured to generate a transient state output signal OS₁(t) according to the filter coefficient W₁(t) and the TIN(t) signal. The delay unit D₂ of the filter tap 303 is configured to delay the TIN(t-1) signal for one more cycle to generate the TIN(t-2) signal. The TIN(t-1) and TIN(t-2) signals could be viewed as different delayed version of the TIN(t) signal. The multiplier M₂ is configured to multiply the TIN(t-1) signal by the filter coefficient W₂(t). The adder A₁ is configured to add the outputs of multipliers (such as the outputs of the multipliers M₁ and M₂) corresponding to different timings of delayed TIN signals to generate a transient state output signal OS₂(t).

The delay unit D₃, the multiplier M₃, and the adder A₂ of the filter tap 305 are analogous to the delay unit D₂, the multiplier M₂, and the adder A₁ of the filter tap 303, respectively, but function with different filtering coefficients and signals. Personnel ordinary skilled in the art could understand the operations of these elements from FIG. 3, and further descriptions are omitted herein. The transient state output signal of the adder of the last stage of filter tap is the output signal OS. However, the structure shown in FIG. 3 is merely an example, and cannot be used to limit the scope of the present invention. Adaptive filters implemented in other structures also fall in the scope of the present invention.

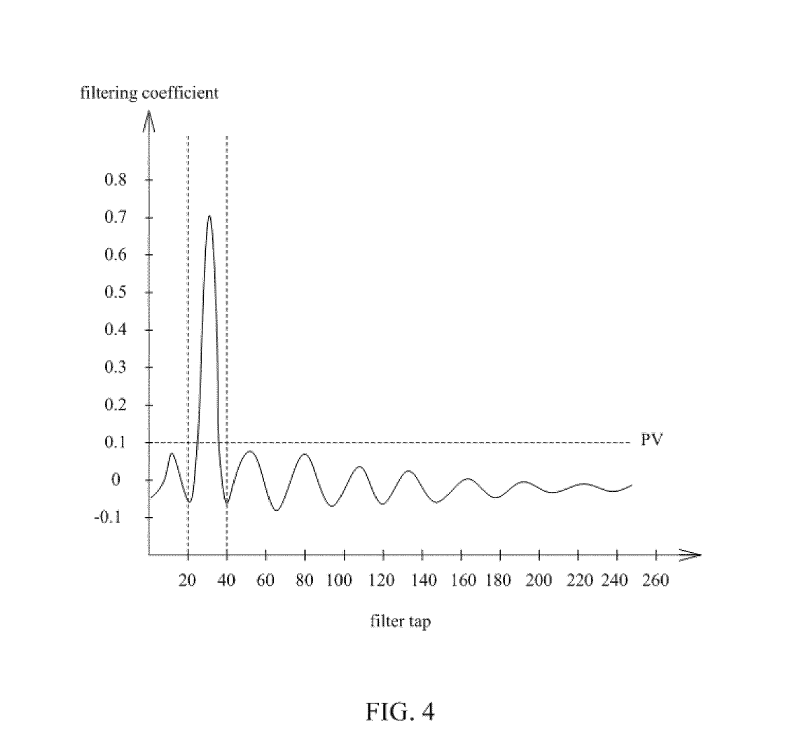

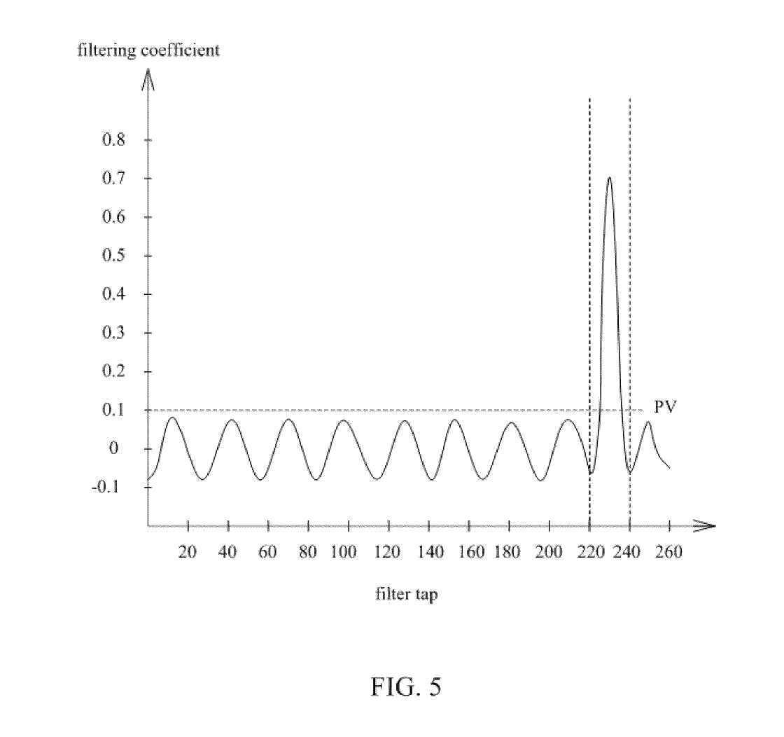

FIG. 4 and FIG. 5 illustrate details of filter tap shrinking performed by the signal filtering apparatus in FIG. 2. As shown in FIG. 4, the horizontal axis represents the order of the filter taps. In the embodiment shown in FIG. 3, the filter tap 301 is the first stage, the filter tap 303 is the second stage, and the filter tap 305 is the third and the last stage. The vertical axis represents filtering coefficient values of these filter taps. For example, the sixtieth filter tap corresponds to a scale 0.09 of the vertical axis. Thus, the filtering coefficient of the sixtieth filter gap is 0.09. In the case shown in FIG. 4, the filtering coefficients of the twentieth to the fortieth filter taps are relatively higher. The filtering coefficients of the rest filter taps are all below a predetermined value PV (the PV value is 0.1 in this case, which is not used to limit the scope of the present invention.) In other words, the input signal has relatively greater frequency responses at the twentieth to the fortieth filter taps, and the rest of filter taps are determined as low-frequency-response filter taps. Thus, the control circuit would perform filter tap shrinking on these low-frequency-response filter taps. The filter tap shrinking operation is to exclude the outputs of the shrunk filter taps. Hence, there are multiple methods to meet this requirement. Take the embodiment in FIG. 3 as an example, if the filter tap 301 is determined as a low-frequency-response filter tap, after the filter tap 301 receives the TIN(t) signal, the TIN(t-1) signal would be passed to the next stage filter tap 303 and the transient state output signal OS₁(t) would not be produced by the multiplier M₁. In other words, the filter tap 301 does not output any signals other than the TIN(t-1) signal to the next stage filter tap 303. In an alternative way, the control circuit excludes the produced outputs of the low-frequency-response filter taps. Take the embodiment in FIG. 3 as an example, if the filter tap 301 is determined as a low-frequency-response filter tap, the transient state output signal OS₁(t) would not be added to the transient state output signal OS₂(t). However, please be aware that the filter tap shrinking operation is not limited to these two implementations. Any equivalent operations achieving the same function should be included in the scope of the present invention. In such arrangement, the timings of signals received by the twentieth to the fortieth filter taps are identical to the timings of signals received by the original twentieth to the fortieth filter taps. And the output signal of the fortieth filter tap would be taken as the output signal of the adaptive filter.

According to the present invention, not all outputs from every filter taps need to be calculated. However, please note that the present invention does not limit to shrink all of the filter taps other than the twentieth to the fortieth filter taps. Shrinking a part of the filter taps other than the twentieth to the fortieth filter taps is also intended to be included by the present invention. For example, although only the filtering coefficients of the twentieth to the fortieth filter taps are relatively higher, it may be presumed that filter taps neighboring to the twentieth to the fortieth filter taps may also have higher filtering coefficients with respect to the next TIN signal. In consequence, the tenth to the fiftieth filter taps may also be preserved and the rest of filter taps are shrunk. In the embodiment shown in FIG. 5, the 220^{th} to 240^{th} filter taps have relatively higher filtering coefficients and the filtering coefficients of the rest of filter taps are below the predetermined value PV and are determined as low-frequency-response filter taps. Based on the same idea, the control circuit performs filter tap shrink operations to at least part of these low-frequency-response filter taps.

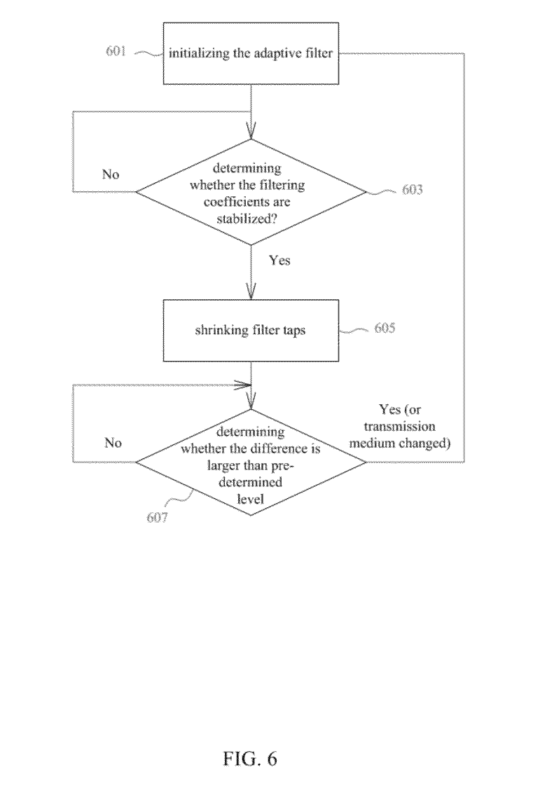

Please refer to FIG. 6, which depicts a flowchart diagram of the operation performed by the adaptive filter shown in FIG. 2. The flow comprises the following steps:

Step 601: initializing the adaptive filter.

Step 603: determining whether the filtering coefficients are stabilized. As mentioned above, the adaptive filter is configured to iteratively adjust the filtering coefficients until the difference between the output signal and original input signal is less than or equals to a predetermined level. When the difference is less than or equals to the predetermined level, the filtering coefficients would not be adjusted again and stabilized, until the difference is again larger than the predetermined level.

Step 605: determining whether the stabilized filtering coefficient are less than a predetermined value and shrining filter taps accordingly.

Step 607: processing the original input signal by the adaptive filter with shrunk filter taps. The difference between the output signal and the original input signal is monitored continuously. If the difference is less than or equals to the predetermined level, the adaptive filter does not adjust the filtering coefficients. If the difference is larger than the predetermined level, which implies the environment may be changed, the flow goes back Step 601 to have the adaptive filter adjusting again.

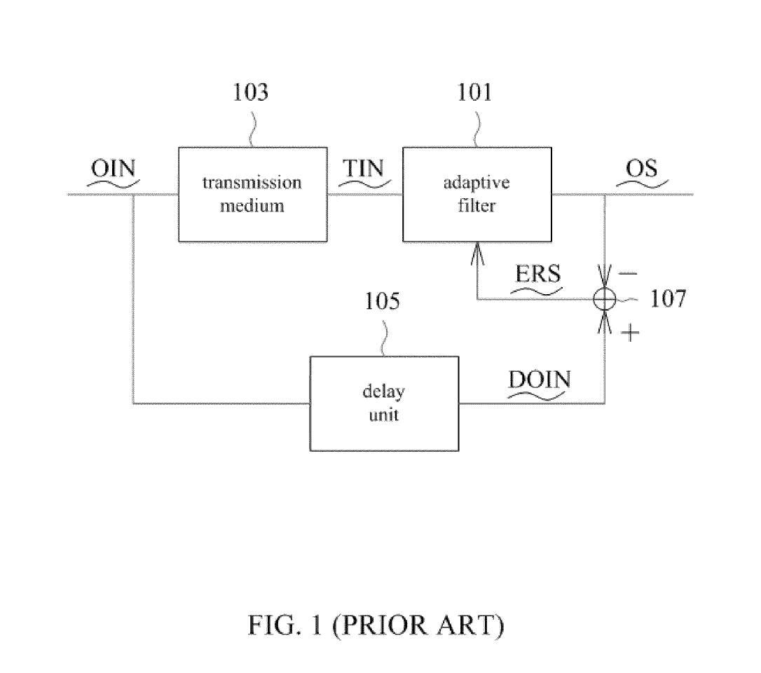

However, please note that the embodiments use the adaptive filters as examples. It does not limit the mechanism to the adaptive filters. Other filters are also applicable. Besides, the processed signals are not limited to audio signal mentioned in the content related to FIG. 1.

Accordingly, a signal filtering method could be concluded according to the fore-mentioned embodiments, which comprises the following steps: receiving a transmitted input signal TIN and generating an output signal OS by transmitted input signals corresponding to different timings processed by filter taps with different filter coefficients in a filter; and perform a filter tap shrink operation to at least part of low-frequency-response filter taps having filter coefficients which are less than a predetermined value.

According to the fore-mentioned embodiments, outputs of lower frequency response filter taps are not calculated. Hence, electric energy could be saved and the convergence speed of the filtering coefficients could be accelerated.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A signal filtering apparatus, comprising:
a control circuit; and
a filter, configured to receive a transmitted input signal and generate an output signal, comprising a plurality of filter taps for processing the transmitted input signal corresponding to different timings with different filter coefficients, respectively;
wherein the control circuit performs filter tap shrinking on at least a part of low-frequency-response filter taps having filter coefficients less than a predetermined value.

2. The signal filtering apparatus of claim 1, wherein the filter tap shrinking comprises at least one of the following operations:
the control circuit controls each of the at least a part of the low-frequency-response filter taps not to output any signal other than the transmitted input signal corresponding to the different timing to a next stage of the filter tap; and
the control circuit controls the filter to exclude outputs from the at least part of the low-frequency-response filter taps while generating the output signal.

3. The signal filtering apparatus of claim 1, wherein the transmitted input signal is an original input signal traversing through a transmission medium and the control circuit further adjusts iteratively the filter coefficients until the difference between the output signal and the original input signal is less than or equals to a predetermined level.

4. The signal filtering apparatus of claim 3, wherein the filter is an adaptive filter.

5. The signal filtering apparatus of claim 1, wherein the control circuit further determines the difference between the original input signal and a next transmitted input signal, and after the filter tap shrinking, the filter taps process the transmitted input signal again when the difference between the original input signal and the next transmitted input signal is larger than a predetermined level.

6. The signal filtering apparatus of claim 1, wherein each of the filter taps comprising:
a delay unit, configured to delay the transmitted input signal or a delayed version of the transmitted input signal to generate a delayed transmitted input signal;
a multiplier, configured to multiply the delayed transmitted input signal from the previous stage of filter tap by the corresponding filter coefficient; and
an adder, configured to add outputs of the multipliers corresponding to different versions of the delayed transmitted input signal in order to generate a transient output signal;
wherein output of the last stage of filter tap is the output signal.

7. A signal filtering method, comprising:
receiving a transmitted input signal and processing the transmitted input signal corresponding to different timings by a plurality of filter taps of a filter with different filter coefficients, respectively, to generate an output signal; and
shrinking at least a part of low-frequency-response filter taps having filter coefficients less than a predetermined value.

8. The signal filtering method of claim 7, wherein the filter tap shrinking step comprises at least one of the following steps:
controlling each of the at least part of the low-frequency-response filter taps not to output any signal other than the transmitted input signal corresponding to the different timing to a next stage of the filter tap; and
excluding outputs from the at least part of the low-frequency-response filter taps while generating the output signal.

9. The signal filtering method of claim 7, wherein the transmitted input signal is an original input signal traversing through a transmission medium and the signal filtering method further comprising adjusting iteratively the filter coefficients until the difference between the output signal and the original input signal is less than or equals to a predetermined level.

10. The signal filtering method of claim 7, wherein the filter is an adaptive filter.

11. The signal filtering method of claim 7, further comprising:
determining the difference between the original input signal and a next transmitted input signal, and after the filter tap shrinking step, processing the transmitted input signal again when the difference between the original input signal and the next transmitted input signal is larger than a predetermined level.
